(19) United States
(12) Patent Application Publication
(10) Pub. No.: US 2014/0132419 A1
(43) Pub. Date: May 15, 2014

(54) REMOTE DIAGNOSTIC SYSTEM AND METHOD

(71) Applicant: Martin Schumann, Ottawa (CA)

(72) Inventor: Martin Schumann, Ottawa (CA)

(21) Appl. No.: 13/322,873

(22) PCT Filed: Nov. 2, 2011
(86) PCT No.: PCT/IB2011/054875

§ 371 Date: Nov. 28, 2011

Related U.S. Application Data
(60) Provisional application No. 61/389,126, filed on Oct. 1, 2010.

(51) Int. Cl. G08B 5/36; G08B 3/10

(52) U.S. Cl. CPC G08B 5/36; G08B 3/10
USPC 340/815.45

(57) ABSTRACT

A remote diagnostic system is disclosed comprising a device having at least one annunciator operatively connected to the device for conveying a signal representative of at least one device state. A modulator modulates the annunciator signal to allow additional data to be digitally encoded into the annunciator signal. A signal capture means creates a digital recording of the annunciator signal which is transmitted to the digital recording to another location for interpretation of the additional data.

### CROSS REFERENCE TO RELATED APPLICATIONS

This application claims the benefit of US Provisional Patent Application No. 61/389,126 filed on Oct. 1, 2010 by the same inventor for the same invention.

### FEDERAL FUNDING

N/A

### FIELD OF THE INVENTION

This invention relates to diagnostic systems and methods of remote equipment.

### BACKGROUND OF THE INVENTION

Many products exist that include LED or other visual or audio indicators of the product state which are designed to be read by a human. Such indicators may generally communicate a limited set of information based on the ability for the human to differentiate between steady indicators, different flash rates or different pulse rates as it understood in the art. For example, a device may indicate what state it is in by flashing an indicator five times followed by a pause to show that the device is in state five. The human may then require a table, manual or other documentation to understand the implications of the device being in such a state. LED indicators can be produced with multiple colours which indicate the power on system test (POST) state of a computer system through the use of multi-coloured LEDs to indicate good (green) or bad (red) conditions. LED indicators may also be arranged in specific patterns or with specific purposes to communicate the condition of individual parts of a system. In another example information is displayed POST information by lighting up specific LEDs in a variety of patterns during each POST test. If the LED patterns stop changing then the last pattern displayed indicates which specific test failed. Where more detailed diagnostic information is required, systems generally rely on text display screens, on electrical storage or electrical communication connections, or they require specialized tools that can connect to the system in order to read the diagnostic information from the system. There exists a need for a diagnostic system that would allow a simple system with as few as one single indicator lights to communicate complex diagnostic information to a human. There further exists a need for such diagnostic information to be accessible by a human without the need for specialized tools. There also exists a need for such diagnostic information to be stored and transmitted in a way that allows immediate action by a remote person or system.

### SUMMARY OF THE INVENTION

In a preferred embodiment of the invention the system is composed of a single LED indicator that would normally be used to communicate a maximum of three states to a human being, those states being ‘Not Ready’ when the LED is off, ‘Ready’ when the LED is on, and ‘Problem’ when the LED is flashing. The single indicator could also be a ‘fault’ lamp that only lights up in the case of a fault. The single indicator could also be a ‘data ready’ or similar indicator that tells the user that diagnostic information of a general nature is waiting to be read by the operator.

Diagnostic information may include information about system performance, health, service information and fault information. Even in situations where the system is operating normally, service operators may wish to retrieve and analyse the diagnostic information stored in the system for preventative maintenance, research, tracking or even business purposes to learn how often the system is used.

In the preferred embodiment, when the LED is lit, the LED would be further modulated rapidly on-and-off during the lit periods, where it appears to the user to be on steady, or nearly steady. For example, the LED could be rapidly turned on and off at a rate of up to 6 times per second. This would appear to the human as a barely noticeable flickering. The human would be instructed during problem conditions to use the camera built into their cellular phones to video tape the operation of the indicator. Most service technicians carry cellular telephones or other communication devices. Video features are built into many of these devices and would therefore not be considered a special tool. Video capture for standard television broadcasts occurs at rates of around 50 to 60 frames per second. Portable devices may use frame rates that are slower such as 30, 15 or even 10 frames per second. The modulation rate of the LED is chosen such that the modulation can be detected, even with slow frame rates. As portable video equipment improves, the frame rate for the preferred embodiment may be increased. Provided the modulation can been detected on the resulting video, the modulation rate may be increased. The video would be sent to the central dispatch office which would use software to slow down and either manually count (by a human), or automatically decode the diagnostic information that is being communicated through different modulation schemes in the flickering of the LED indicator as seen in the video. The methods used to encode data into an on-off signal are well understood as this mimics the on-off encoding that might be found in any serial data stream. Such encoding could be based on older standards of communication such as RS-232 serial, Manchester encoding, pulse width modulation or it could be based on newer communication standards such as fire wire, or USB. Alternate embodiments of the design would allow for multiple LED indicators to be used, dramatically increasing the volume of information that can be communicated. For example, battery packs often include graphical LED indicators where 5 LED's are used to communicate the charge level of the battery in increments of 0-20, 20-40, 40-60, 60-80, 80-100 percent charge. The use of 5 LED's would effectively provide 5 independent communication paths for a 2⁵ increase in data (32 times). These indicators can also be used to display special diagnostic codes to the human user by lighting up in a way that is distinct from the capacity reading. For example, lighting up only the 20-40 and 80-100 LED's may indicate a particular fault condition. Use of this encoding strategy would allow all 5 LEDs to be flickered at an update rate of perhaps 6 times per second while still being accurately captured on a simple video capture device. This would produce an effective data rate of approximately 5 bits of data 6 times per second. The raw bit-rate for sending diagnostic information would therefore be 192 bits per second. Again referring to the battery pack, if the pack contained 576 bits of diagnostic data (about 80 characters), this would only require 3 seconds of video capture. The proliferation of devices with built in video cameras and the increase in processing abilities of such devices would allow software to be loaded into the operators phone to allow real-time interpretation of the diagnostic data stream. The ability to create simple software applications continues to get easier with the advent of open development platforms such as Google's Android (™) operating system. It is therefore envisioned that the majority of professionals will, in the future, have the ability to download a software application on their phone that could analyse a real-time video stream to interpret the rapidly flashing indicators on any product from a coffee-maker to a rocket ship. This ability will improve the ability of humans to interact with the growing variety of technology equipment that today is drastically limited in its ability to communicate diagnostic information to humans. The object of the system is to allow an end product such as a coffee maker, furnace, battery, etc. to communicate a large amount of diagnostic information to a human, without the need for the human operator to make a physical connection to the end product, without requiring special tools or training. The system provides a way of reading a significant amount of diagnostic information from an end product using no special tools, only a video phone, even if the system has only one external indicator, the system described herein will allow a nearly unlimited amount of data to be read from the end product and analysed.

### BRIEF DESCRIPTION OF THE DRAWINGS

FIG. 1 shows one preferred embodiment of the system of the invention.

### DETAILED DESCRIPTION

The complete invention can be summarized as a system and method to allow verbose diagnostic information to be communicated using any enunciator normally used to communicate simple information to a human, but to modulate the enunciator in a way that a portable recording device can capture the annunciations and thereby provide additional insight into the diagnostic data coming from the system. It can be easily understood that the number, colour, flash rates, shape, brightness, magnitude, pulse width and other encoding schemes used on the indicators could be adapted to increase data rates and to simplify decoding of the information being communicated. Additionally, other enunciators could be used such as an audio speaker, error buzzer or alarm bell. These other enunciators could be used on their own, or in combination with other enunciators to increase the amount of data being sent.

The rate of modulation could be slowed down so it is detectable by the human without harming the intent of the invention to encode more data than a human would easily be able to follow.

As technology in the recording devices improves, it will be possible to speed up the rate of modulation. For example, if the video capture device operates at 60 frames per second, then flashing an indicator at 20 times per second should be clearly visible, but a system which captures at only 20 frames per second may require the flashing indicator to operate at only 6 flashes per second.

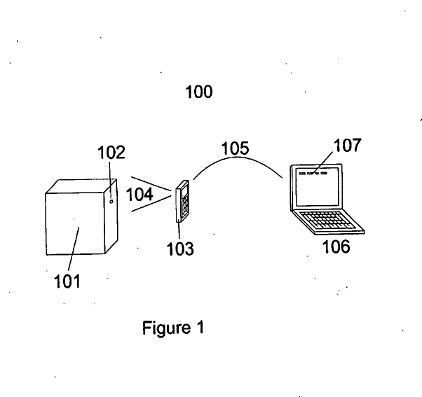

Referring to FIG. 1, the preferred embodiment is shown (100) as a general end product (101) represented here as simply a box. The end product (101) could be anything that has an annunciator on it and can include coffee makers, toasters, oven, music equipment, batteries, automobiles, etc. In the figure, the annunciator is an LED indicator (102).

A phone with a built-in video camera (103) is used to capture video of the LED (102) by ensuring the camera's field of view (104) includes the LED. The video is then sent to another location either by store and forward, streaming, wired or wireless methods to a computer (106) which interprets the information encoded into the modulation of the LED indicator. The computer may then display the resulting diagnostic information (107) for the remotely located technician to interpret.

There are many alternate embodiments of this concept that would not depart from the fundamental nature of using a video, audio or other recording means to capture modulated data from a single annunciator in an end product, and to then decode the modulation to interpret the diagnostic data being sent by the end product.

An alternate embodiment would send the decoded diagnostic information (107) directly back to the phone (103) to be displayed. This could be done without any interference by the remote technical operator, instead the computer itself could perform interpretation of the data, if any, that is required.

For simple encoding methods, or with increases in processing speeds, the phone itself (103) may be able to decode the modulated information directly from the built in camera without the need to actually record, store, transmit (105) or remotely interpret (107) the diagnostic data. Instead the phone itself would perform all functions needed for the human user to understand the state of the end product (101).

For remote monitoring without a human, a dedicated camera, microphone or even the existing security system of an office could be used to monitor the annunciators of a variety of equipment, and would recognize and diagnose any changes in the monitoring field of the system. Therefore, if a computer started beeping during the night, the security system would hear the beeping, decode the modulation that is superimposed in the beep, and could then take action based on the diagnostic information received.

Although the description above contains much specificity, these should not be construed as limiting the scope of the invention but as merely providing illustrations of the presently preferred embodiment of this invention. Thus the scope of the invention should be determined by the appended claims and their legal equivalents.

What is claimed is:

1. A remote diagnostic system comprising a device having at least one annunciator operatively connected to said device for conveying a signal representative of at least one device state, a means for further modulating said annunciator signal to allow additional data to be digitally encoded into the annunciator signal capture means for creating a digital recording of the annunciator signal, transmission means for transmitting said digital recording to another location for interpretation of the said additional data.

2. The system of claim 1 wherein the annunciator is human readable to provide basic system state information composed of at most 3 bits worth of information per annunciator.

3. The system of claim 1 wherein the annunciator is a LED.

4. The system of claim 1 wherein on the annunciator is an audio speaker.

5. The system of claim 3 wherein said first predetermined pattern further encodes a second predetermined pattern beyond visual perception of the human operator wherein said second predetermined pattern encodes a specific fault.

6. The system of claim 1 wherein the signal capture means and the transmission means are both part of a cellular telephone.

7. A method for remote diagnosis of a device comprising the following steps:
a. providing a device which contains diagnostic data;
b. having an annunciator configured as part of the device for human communication of a first state;
c. modulating the annunciator such that diagnostic information can be detected by a separate recording device without affecting the annunciators ability to communicate the first state to a human; and,
d. decoding the recorded annunciator signal to recover the diagnostic data embedded therein.

8. The method of claim 7 further comprising the step of displaying the diagnostic information to the operator.

9. The method of claim 7 further comprising the step of the recording device performing an action based on the contents of the diagnostic information.
